(19) United States
(12) Patent Application Publication
(10) Pub. No.: US 2020/0112197 A1
(43) Pub. Date: Apr. 9, 2020

(54) PORTABLE CHARGING DEVICE AND CHARGING SYSTEM

(71) Applicants: Kaiwen Zhang, Calabasas, CA (US); Bi Tian Yuan, Manhasset, NY (US)

(72) Inventors: Kaiwen Zhang, Calabasas, CA (US); Bi Tian Yuan, Manhasset, NY (US)

(21) Appl. No.: 16/153,630

(22) Filed: Oct. 5, 2018

(51) Int. Cl. H02J 7/35; H02J 7/00; B62J 6/02; B62J 6/04; B62J 99/00; B60Q 1/00

(52) U.S. Cl. CPC H02J 7/35; H02J 7/0068; H02J 7/0052; B62J 6/02; B62J 2099/004; B62J 99/00; B60Q 1/0017; H02J 2007/0062; H02J 7/0054; B62J 6/04

(57) ABSTRACT

The present application discloses a portable charging device for transportation. The portable charging device comprises a body, a solar panel and a connector. The solar panel is coupled to the body. The connector is coupled to the body, the solar panel and an electronic device, wherein the solar panel is capable of charging the electronic device. A charging system is also disclosed. The charging system comprises a bike and a portable charging device coupled to the bike. The portable charging device comprises a body, a solar panel and a connector. The solar panel is coupled to the body. The connector is coupled to the body, the solar panel and an electronic device, wherein the solar panel is capable of charging the electronic device.

### TECHNICAL FIELD OF THE INVENTION

The present application generally relates to chargers, and more particularly, to a portable charging device and a charging system.

### BACKGROUND OF THE INVENTION

Generally, drivers of two-wheel transportation such as motorcycle or bike cannot charge their devices via built-in charger as cigar lighter socket of an automobile.

In addition, the users generally install lighters on the front/rear side of the motorcycle or bike for safety. However, such lighters are charged by batteries, resulting in high-cost and environmental-unfriendly problems.

Therefore, a need remains for a portable charging device and a charging system to provide a more convenient and more environmental friendly way for the drivers of two-wheel transportation.

### SUMMARY OF THE INVENTION

The present application discloses a portable charging device and a charging system to provide a more convenient and more environmental friendly way for the drivers of two-wheel transportation.

The portable charging device for transportation comprising a body, a solar panel and a connector. The solar panel is coupled to the body. The connector is coupled to the body, the solar panel and an electronic device, wherein the solar panel is capable of charging the electronic device.

In various exemplary embodiments, the portable charging device for transportation further comprises at least one light emitter installed onto the body. Specifically, the at least one light emitter is installed onto the body via at least one clamp. The light emitter is a light emitting diode.

In various exemplary embodiments, the body comprises a USB port.

In various exemplary embodiments, the body comprises a bottom surface, a front wall, a rear wall, a right side wall, a left side wall and a central wall, wherein the central wall, the left side wall and the bottom surface form an accommodation space for the electronic device.

In various exemplary embodiments, the portable charging device for transportation further comprises a mount coupled to the body. The mount may be a clip mount.

In various exemplary embodiments, the electronic device is a mobile phone, a mobile tablet or a portable power bank.

The charging system is also disclosed. The charging system comprises a bike and a portable charging device coupled to the bike. The portable charging device comprises a body, a solar panel and a connector. The solar panel is coupled to the body. The connector is coupled to the body, the solar panel and an electronic device, wherein the solar panel is capable of charging the electronic device.

In various exemplary embodiments, the portable charging device further comprises at least one light emitter installed onto the body. Specifically, the at least one light emitter is installed onto the body via at least one clamp. The light emitter is a light emitting diode.

In various exemplary embodiments, the body comprises a USB port.

In various exemplary embodiments, the body comprises a bottom surface, a front wall, a rear wall, a right side wall, a left side wall and a central wall, wherein the central wall, the left side wall and the bottom surface form an accommodation space for the electronic device.

In various exemplary embodiments, the charging system further comprises a mount coupled to the body and the bike. The mount may be a clip mount.

In various exemplary embodiments, the electronic device is a mobile phone, a mobile tablet or a portable power bank.

In various exemplary embodiments, the portable charging device is installed at a front side or a rear side of the bike.

Based on the above, the present application allows drivers of two-wheel transportation to charge their electronic devices while driving by utilizing a solar panel for charging. In addition, the accommodation space also provides a safer location for the electronic device, reducing the likelihood of being damaged while driving.

Furthermore, the portable charging device may also provide electricity for light emitter, reducing the usage of batteries and providing a more environmentally friendly electric source. Meanwhile, the drivers may also select the location for installing the portable charging device, enhancing the diversity of decoration for the motorcycle or bike.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 illustrates a solar panel of a portable charging device.

FIG. 2 illustrates a body of the portable charging device.

FIG. 3 illustrates the portable charging device.

FIG. 4 illustrates a charging system with the portable charging device installed at the front side of a bike.

FIG. 5 illustrates the charging system with the portable charging device installed at the rear side of the bike.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

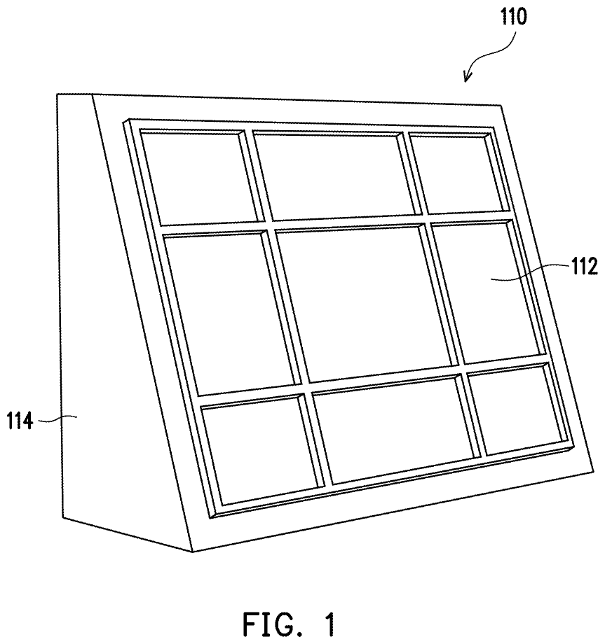

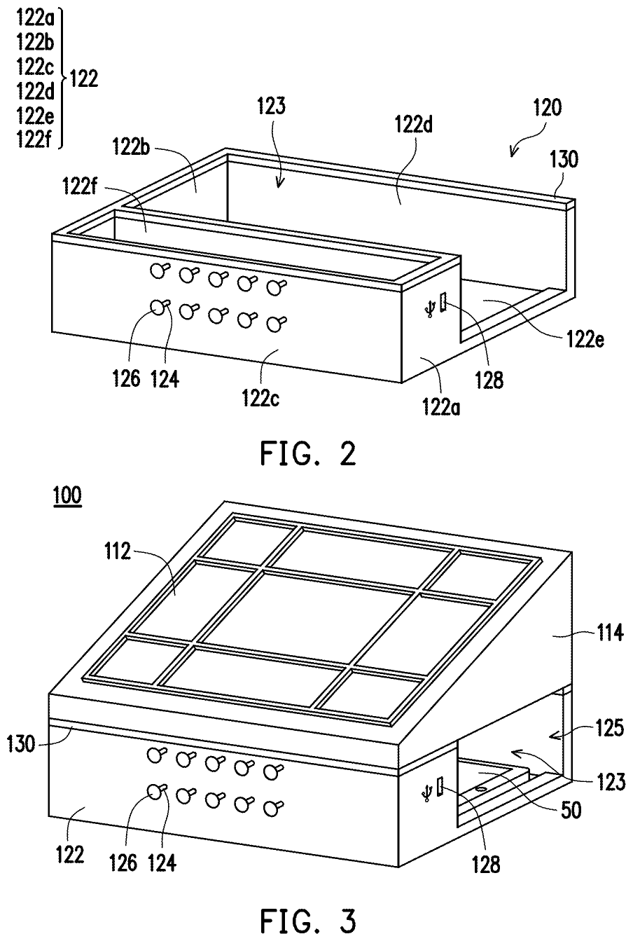

FIG. 1 illustrates a solar panel 110 of a portable charging device 100. FIG. 2 illustrates a body 120 of the portable charging device 100. FIG. 3 illustrates the portable charging device 100.

Referring to FIG. 1, the portable charging device 100 comprises a solar panel 110, a body 120 and a connector 130.

The solar panel 110 comprises a top panel 112, two side walls 114 and bottom surface Specifically, the solar panel 110 is triangular, but the present application is not limited thereto. The solar panel 110 may be any kind of shapes as long as it can convert solar energy into electricity.

The solar panel 110 is coupled to the body 120. Referring to FIGS. 2-3, the body 120 comprises a front wall 122a, a rear wall 122b, a right side wall 122c, a left side wall 122d, a bottom surface 122e and a central wall 122f. The central wall 122f, the left side wall 122d and the bottom surface 122e form an accommodation space for an electronic device 50. Specifically, a width of the front wall 122a is shorter than a width of the rear wall 122b, creating an opening 125 for placing the electronic device 50.

In addition, the body 120 further comprises a USB port 128. Specifically, the USB port 128 of the present application is located at the front wall 122a for charging the electronic device 50 easier. However, the present application is not limited thereto, the USB port 128 may locate at anywhere of the body 120.

Furthermore, the body 120 further comprises at least one light emitter 126 installed onto the body 120. The light emitters 126 in the present application are light emitting diodes as an example, but the present application is not limited thereto. The light emitters 126 are installed onto the body 120 via clamps 124. However, the light emitters 126 may also be inserted into the body 120, the present application is not limited in the method of installing the light emitters 126 either. By doing so, the user may choose the desired color for their device, creating a more diverse selection for the user.

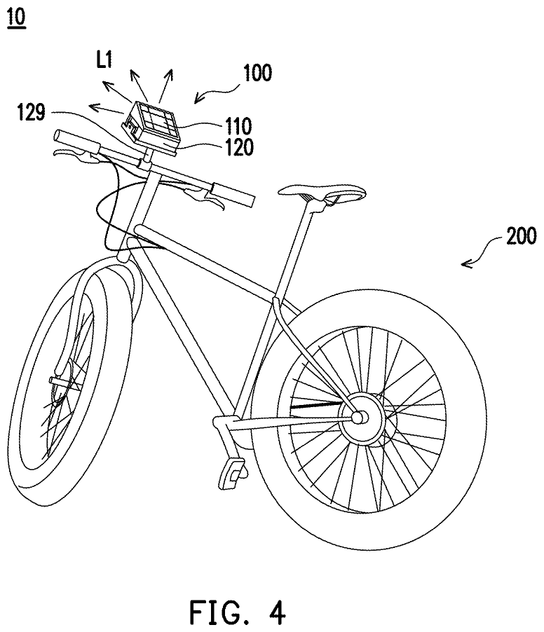

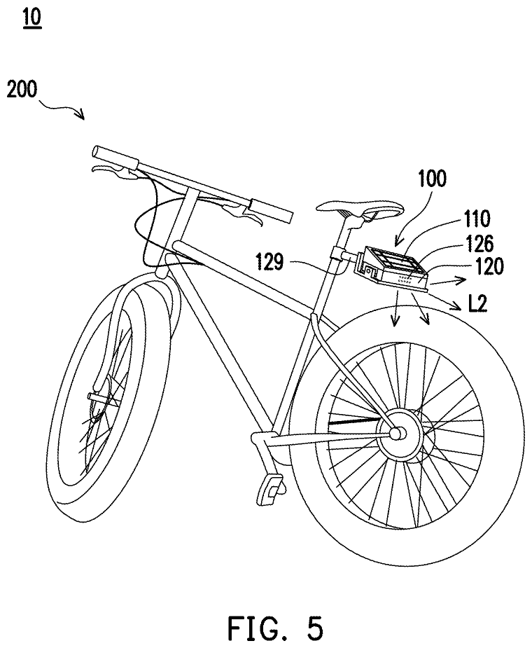

The location of the light emitters 126 will be described in detail in FIGS. 4-5.

The connector 130 is coupled to the solar panel 110 the body 120 and the electronic device 50. Specifically, the connector 130 is located at the top of the body 120, and is capable of converting solar energy absorbed by the solar panel 110 to electricity. It should be noted that the connector 130 may be disposed at any locations as long as it can reach the above purpose, the present application is not limited thereto.

The electronic device 50 in the present application may be a mobile phone, a mobile tablet or a portable power bank. However, the present application is not limited thereto, the electronic device 50 may be any kind of devices as long as it can be charged via the portable charging device 100.

FIG. 4 illustrates a charging system 10 with the portable charging device 100 installed at the front side of a bike 200. FIG. 5 illustrates the charging system 10 with the portable charging device 100 installed at the rear side of the bike 200.

Referring to FIGS. 4-5, the charging system 10 comprises a transportation and the portable charging device 100. In the present application, the transportation is a two-wheel transportation such as motorcycle or bike. The present application utilizes the bike as an example.

The portable charging device 100 may further comprise a mount 129 coupled to the body 120. The mount 129 in the present application is a clip mount, which enable the portable charging device 100 to be installed at any locations of the bike 50. For example, the portable charging device 100 in FIG. 4 is installed at a front side of the bike 200 by coupling the handle of the bike 200 and the bottom surface and the side walls of the body 120. On the other hand, referring to FIG. 5, the portable charging device 100 may be installed at a rear side of the bike 200 by coupling the rod below the bike chair and the rear wall and the side walls of the body 120. It should be noted that the location for installing the portable charging device 100 is not limited at the front side or rear side of the bike 200 the driver can select their own desired location for installation.

In addition, the light emitters 126 may also be located at any location on the body 120. For example, referring to FIG. 4, the light L1 is shining toward the front side, showing that the light emitters 126 are disposed at the right side wall 122c (referring to FIG. 2) of the body 120. On the other hand, referring to FIG. 5, the light L2 is shining toward the rear side, showing that the light emitters 126 are disposed at the left side wall 122d (referring to FIG. 2) of the body 120. It should be noted that FIGS. 4-5 are only presented as examples, the light emitters 126 may be disposed at any location according to user demands.

Based on the above, the present application allows drivers of two-wheel transportation to charge their electronic devices while driving by utilizing a solar panel for charging. In addition, the accommodation space also provides a safer location for the electronic device, reducing the likelihood of being damaged while driving.

Furthermore, the portable charging device may also provide electricity for light emitter, reducing the usage of batteries and providing a more environmentally friendly electric source. Meanwhile, the drivers may also select the location for installing the portable charging device, enhancing the diversity of decoration for the motorcycle or bike.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A portable charging device for transportation comprising:
a body;
a solar panel coupled to the body; and
a connector coupled to the body, the solar panel and an electronic device, wherein the solar panel is capable of charging the electronic device.

2. The portable charging device for transportation as claimed in claim 1, further comprises at least one light emitter installed onto the body.

3. The portable charging device for transportation as claimed in claim 2, wherein the light emitter is a light emitting diode.

4. The portable charging device for transportation as claimed in claim 2, wherein the at least one light emitter is installed onto the body via at least one clamp.

5. The portable charging device for transportation as claimed in claim 1, wherein the body comprises a USB port.

6. The portable charging device for transportation as claimed in claim 1, wherein the body comprises a bottom surface, a front wall, a rear wall, a right side wall, a left side wall and a central wall, wherein the central wall, the left side wall and the bottom surface form an accommodation space for the electronic device.

7. The portable charging device for transportation as claimed in claim 1, further comprising a mount coupled to the body.

8. The portable charging device for transportation as claimed in claim 7, wherein the mount s a clip mount.

9. The portable charging device for transportation as claimed in claim 1, wherein the electronic device is a mobile phone, a mobile tablet or a portable power bank.

10. The portable charging device for transportation as claimed in claim 1, wherein the portable charging device is installed onto a bike.

11. A charging system comprising:
a bike; and
a portable charging device coupled to the bike and comprising:
a body;
a solar panel coupled to the body; and
a connector coupled to the body, the solar panel and an electronic device, wherein the solar panel is capable of charging the electronic device.

12. The charging system as claimed in claim 11, wherein the portable charging device further comprises at least one light emitter installed onto the body.

13. The charging system as claimed in claim 12, wherein the light emitter is a light emitting diode.

14. The charging system as claimed in claim 12, wherein the at least one light emitter is installed onto the body via at least one clamp.

15. The charging system as claimed in claim 11, wherein the body comprises a USB port.

16. The charging system as claimed in claim 11, wherein the body comprises a bottom surface, a front wall, a rear wall, a right side wall, a left side wall and a central wall, wherein the central wall, the left side wall and the bottom surface form an accommodation space for the electronic device.

17. The charging system as claimed in claim 11, further comprising a mount coupled to the body and the bike.

18. The charging system as claimed in claim 17, wherein the mount is a clip mount.

19. The charging system as claimed in claim 11, wherein the electronic device is a mobile phone, a mobile tablet or a portable power bank.

20. The charging system as claimed in claim 11, wherein the portable charging device is installed at a front side or a rear side of the bike.
